(19) United States
(12) Patent Application Publication
(10) Pub. No.: US 2022/0371091 A1
(43) Pub. Date: Nov. 24, 2022

(54) DIRECTED ENERGY DEPOSITION (DED) REINFORCEMENTS ON BODY STRUCTURES AND VISIBLE SHEET METAL SURFACES

(71) Applicant: Ford Global Technologies, LLC, Dearborn, MI (US)

(72) Inventors: Adam Weyrauch, Canton, MI (US); Steven Frank, Dearborn, MI (US)

(73) Assignee: Ford Global Technologies, LLC, Dearborn, MI (US)

(21) Appl. No.: 17/324,297

(22) Filed: May 19, 2021

(51) Int. Cl. B22F 7/08; B23K 26/342; B33Y 10/00; B33Y 80/00; B33Y 40/10; B22F 10/25; B32B 15/01

(52) U.S. Cl. CPC B22F 7/08; B23K 26/342; B33Y 10/00; B33Y 80/00; B33Y 40/10; B22F 10/25; B32B 15/011; B32B 15/016; B22F 2301/35; B22F 2301/052

(57) ABSTRACT

A part includes a sheet metal component having a predefined shape and at least one additively manufactured reinforcement deposited on, metallurgically bonded to, and extending along a surface of the sheet metal component. The at least one additively manufactured reinforcement can be a directed energy deposition (DED) reinforcement rib. Also, the at least one additively manufactured reinforcement can be deposited on the piece of sheet metal before the piece of sheet metal is formed into the predefined shape, or in the alternative, the at least one additively manufactured reinforcement can be deposited on the piece of sheet metal after the piece of sheet metal is formed into the predefined shape.

### FIELD

The present disclosure relates to sheet metal components and particularly to reinforcement of sheet metal components.

### BACKGROUND

The statements in this section merely provide background information related to the present disclosure and may not constitute prior art.

Sheet metal components with a range of shapes, structural features and/or one or more visually aesthetic surfaces are used in the assembly of vehicles. And such sheet metal components can include reinforcements to provide enhanced structural rigidity and strength. However, designing and including reinforcements for sheet metal components can be cost and time prohibitive depending on the material and expected loading scenario of the sheet metal component.

The present disclosure addresses the issues of forming sheet metal components with reinforcements, among other issues related to forming sheet metal components.

### SUMMARY

This section provides a general summary of the disclosure and is not a comprehensive disclosure of its full scope or all of its features.

In one form of the present disclosure a part includes a sheet metal component formed into a predefined shape and at least one additively manufactured reinforcement deposited on, metallurgically bonded to, and extending along a surface of the sheet metal component.

In some variations, the at least one additively manufactured reinforcement is formed by directed energy deposition (DED).

In at least one variation, the at least one additively manufactured reinforcement is deposited on a piece of sheet metal before the piece of sheet metal is formed into the predefined shape. In another variation, the at least one additively manufactured reinforcement is deposited on the piece of sheet metal after the piece of sheet metal is formed into the predefined shape.

In some variations, the at least one additively manufactured reinforcement is deposited on an oil canning surface of the predefined shape.

In at least one variation, the at least one additively manufactured reinforcement is deposited proximal to an opening in the predefined shape.

In some variations, the piece of sheet metal and the at least one additively manufactured reinforcement are formed from a first material. In other variations, the piece of sheet metal is formed from a first material and the at least one additively manufactured reinforcement is formed from a second material different than the first material. For example, in one variation the piece of sheet metal and the at least one additively manufactured reinforcement are formed from a steel alloy, while in another variation, the piece of sheet metal is formed from a first steel alloy and the at least one additively manufactured reinforcement is formed from a second steel alloy different from the first steel alloy. Also, in some variations the piece of sheet metal is formed from a first aluminum alloy and the at least one additively manufactured reinforcement is formed from a second aluminum alloy different from the first aluminum alloy.

In at least one variation, the piece of sheet metal has a visible sheet metal surface and an interior surface, and the additively manufactured reinforcement is deposited on the interior surface.

In some variations, the at least one additively manufactured reinforcement is a plurality of additively manufactured reinforcement ribs. And in such variations, the plurality of additively manufactured reinforcement ribs can be at least one of a plurality of additively manufactured reinforcement ribs extending parallel to each other and a plurality of additively manufactured reinforcement ribs forming a cross-hatch pattern.

In some variations a motor vehicle includes the part with the least one additively manufactured reinforcement.

In another form of the present disclosure, a method of manufacturing a part includes forming a piece of sheet metal into a predefined shape, and additively manufacturing and metallurgically bonding at least one reinforcement onto the piece of sheet metal such that deformation of the predefined shape is inhibited.

In some variations, the at least one reinforcement is additively manufactured onto the piece of sheet metal after the piece of sheet metal is formed into the predefined shape, while in other variations the at least one reinforcement is additively manufactured onto the piece of sheet metal before the piece of sheet metal is formed into the predefined shape.

In still another form of the present disclosure, a part is formed by a method that includes forming a piece of sheet metal into a predefined shape, and additively manufacturing and metallurgically bonding at least one reinforcement onto the piece of sheet metal such that deformation of the predefined shape is inhibited.

In some variations, additively manufacturing the at least one reinforcement onto the piece of sheet metal includes at least one of additively manufacturing a reinforcement onto the piece of sheet metal before forming the piece of sheet metal into the predefined shape and additively manufacturing a reinforcement onto the piece of sheet metal after forming the piece of sheet metal into the predefined shape.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of a visible surface of a sheet metal component according to the teachings of the present disclosure;

FIG. 1B is a perspective view of an interior surface of the sheet metal component in FIG. 1A;

FIG. 2A is a perspective view of an interior surface of a sheet metal component before a reinforcement is deposited on the interior surface;

FIG. 2B is a perspective view of the interior surface of the sheet metal component in FIG. 2A after a reinforcement is deposited on the interior surface according to the teachings of the present disclosure;

FIG. 3A is a perspective view of a piece of sheet metal before being reinforced and formed into a predefined shape according to the teachings of the present disclosure;

FIG. 3B is a perspective view of an additively manufacturing reinforcement being deposited on a surface of the piece of sheet metal in FIG. 3A;

FIG. 3C is a cross-sectional view of the piece of sheet metal with the reinforcement in FIG. 3B being formed into a sheet metal component according to the teachings of the present disclosure;

FIG. 3D is a perspective view of the sheet metal component formed in FIG. 3C;

FIG. 3E is a plan view of the sheet metal component formed in FIG. 3C;

FIG. 4 is a perspective view of a sheet metal component formed into a predefined shape after an additively manufactured reinforcement is deposited onto a surface of a piece of sheet metal according to the teachings of the present disclosure;

FIG. 5 is a perspective view of another sheet metal component formed into a predefined shape after an additively manufactured reinforcement is deposited onto a surface of a piece of sheet metal according to the teachings of the present disclosure;

FIG. 6 is a perspective view of still another sheet metal component formed according to the teachings of the present disclosure;

FIG. 7 is a flow chart for a method of forming a sheet metal component according to one form of the present disclosure;

FIG. 8 is a flow chart for a method of forming a sheet metal component according to another form of the present disclosure; and

FIG. 9 is a flow chart for a method of forming a sheet metal component according to still another form of the present disclosure

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides sheet metal components with reinforcements and methods of forming sheet metal components with reinforcements that provide enhanced structural rigidity and strength. As used herein, the terms “reinforcement” or “reinforcements” refers to a member or members that provide structural rigidity and/or structural strength to the piece of sheet metal before and/or after it is formed into a sheet metal component with a predefined shape. The sheet metal components include a piece of sheet metal formed into a predefined shape and an additively manufactured reinforcement deposited on and metallurgically bonded to a surface of the sheet metal component. As used herein, the phrase “metallurgically bonded” refers to chemical bonding between a surface of the sheet metal component and an additively manufactured reinforcement deposited on the surface.

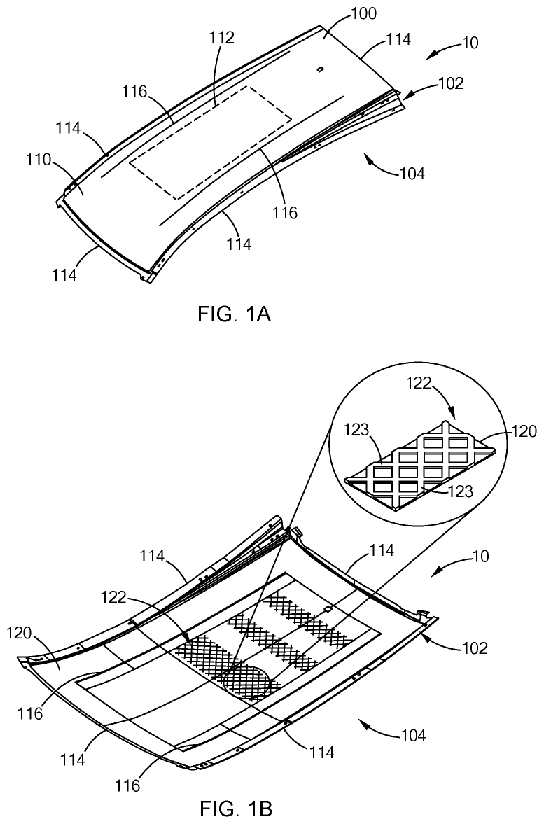

Referring to FIGS. 1A and 1B, a part 10 includes a piece of sheet metal 100 (also referred to herein as a “sheet metal panel”) formed into a sheet metal component 102 with a predefined shape 104 (e.g., a roof panel, a hood panel, among others). The part 10 has a visible sheet metal surface 110 (FIG. 1A, also known as a “visible surface” and a “Class-A surface”), an interior surface 120 (FIG. 1B), and at least one unreinforced area 112 between edges 114 of the sheet metal component 102. It should be understood that the visible sheet metal surface is an exterior surface of the sheet metal component 102 that once assembly onto a motor vehicle an individual, customer, or user can feel, touch and see.

In some variations, the sheet metal component 102 includes one or more stiffeners 116 to provide structural rigidity and/or strength to the sheet metal component 102. For example, stiffeners 116 can include ridges or corners formed in the sheet metal component 102 during stamping, rolling, bending, and/or drawing of the piece of sheet metal 100, and/or a bracket or stiffening member attached to the sheet metal component 102 by welding, riveting and/or use of an adhesive, among others. However, the use of and/or the quantity of stiffeners 116 may limited due to weight and aesthetic design parameters and the unreinforced area 112 can be susceptible to deformation, buckling or waviness (also known as “oil canning”) and the unreinforced area 112 is often referred as an “oil canning surface 112”). Accordingly, and as shown in FIG. 1B, an additively manufactured reinforcement 122 (also referred to herein simply as “reinforcement 122”) is deposited on and metallurgically bonded to the interior surface 120 such that oil canning of the unreinforced area 112 (and the visible sheet metal surface 110) is inhibited. In some variations, the reinforcement 122 is additively manufactured and deposited onto the interior surface 120 via directed energy deposition (DED) such as laser DED, arc DED, and electron beam DED.

In some variations, the reinforcement 122 is in the form of a plurality of additively manufactured reinforcement ribs 123 (also referred to herein simply as “reinforcement ribs 123”) deposited on, metallurgically bonded to and extending along the interior surface 120 after the sheet metal component 100 is formed. That is, the reinforcement 122 is deposited onto and metallurgically bonded to the interior surface 120 after forming of the sheet metal component 100, e.g., via stamping, drawing, rolling, and/or bending of the piece of sheet metal 100. And while the reinforcement 122 shown in FIG. 1B is in the form of a “cross-hatch” pattern, it should be understood that the reinforcement 122 can be in the form of other shapes and patterns such as, but not limited to, a single reinforcement rib 123, a plurality of parallel reinforcement ribs 123, a plurality of non-parallel reinforcement ribs 123 that intersect, a plurality of non-parallel ribs 123 that do not intersect, one or more serpentine shaped reinforcement ribs 123, among others.

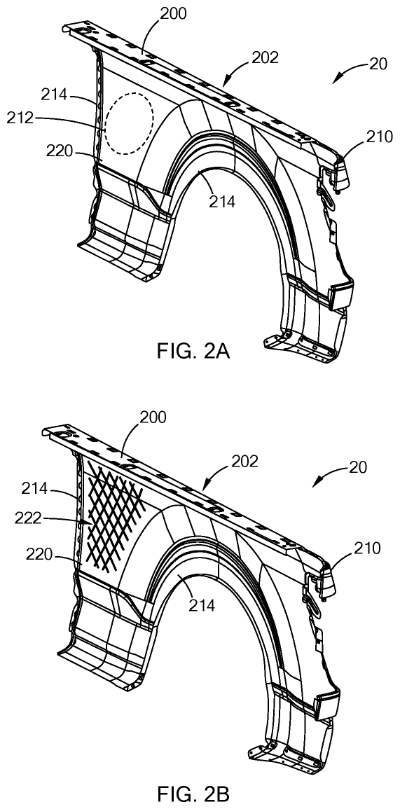

Referring to FIGS. 2A and 2B, a part 20 includes a piece of sheet metal 200 formed into a sheet metal component 202 with a predefined shape 204 (e.g., a panel for a tailgate of a truck). The part 20 has a visible sheet metal surface 210, an interior surface 220, and at least one unreinforced area 212 between edges 214 of the sheet metal component 202. In some variations, the sheet metal component 202 includes one or more stiffeners 216 as described above to provide structural rigidity and/or strength to the sheet metal component 202. However, the unreinforced area 212 can be susceptible to oil canning and the unreinforced area 212 can be an oil canning surface 212. Accordingly, and as shown in FIG. 2B, an additively manufactured reinforcement 222 (also referred to herein simply as “reinforcement 222”) is deposited on and metallurgically bonded to the interior surface 220 such that oil canning of the unreinforced area 212 and the visible sheet metal surface 210 is inhibited. And in some variations, the reinforcement 222 is additively manufactured and deposited onto the interior surface 220 via laser DED, arc DED, or electron beam DED.

In some variations, the reinforcement 222 is in the form of a plurality of additively manufactured reinforcement ribs 223 (also referred to herein simply as “reinforcement ribs 223”) deposited on, metallurgically bonded to and extending along the interior surface 220 after the sheet metal component 202 is formed. That is, the reinforcement 222 is deposited onto and metallurgically bonded to the interior surface 220 after forming of the sheet metal component 202, e.g., via stamping, drawing, rolling, and/or bending of the piece of sheet metal 200. And while the reinforcement 222 shown in FIG. 2B is in the form of a “cross-hatch” pattern, it should be understood that the reinforcement 222 can be in the form of other shapes and patterns such as, but not limited to, a single reinforcement rib 223, a plurality of parallel reinforcement ribs 223, a plurality of non-parallel reinforcement ribs 223 that intersect, a plurality of non-parallel ribs 223 that do not intersect, one or more serpentine shaped reinforcement ribs 223, among others.

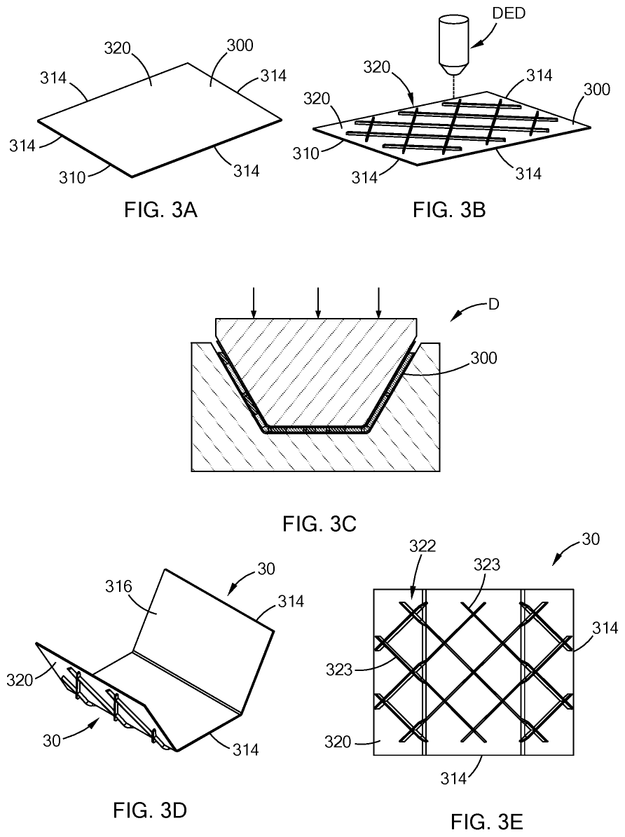

Referring to FIGS. 3A-3E, a part 30 (FIGS. 3D-3E) and forming of the part 30 is shown. The part 30 includes a piece of sheet metal 300 (FIG. 3A) formed into a sheet metal component 302 with a predefined shape 304 (FIGS. 3D-3E). The piece of sheet metal 300 has a first surface 310, a second surface 320, and at least one unreinforced area 312 between edges 314. The unreinforced area 312 can be susceptible to oil canning after the sheet metal component 302 is formed and/or need desired additional support not related to oil canning after the sheet metal component 302 is formed. However, and in the alternative to additively manufacturing a reinforcement onto the sheet metal component 302 after it is formed, the part 30 includes an additively manufactured reinforcement 322 deposited on and metallurgically bonded to the second surface 320 of the piece of sheet metal 300 using a ‘DED’ machine (FIG. 3B) before the sheet metal component 302 is formed, e.g., with a die ‘D’ (FIG. 3C). And in some variations, the reinforcement 322 is additively manufactured and deposited onto the second surface 320 via DED additively manufacturing such as laser DED, arc DED, and electron beam DED.

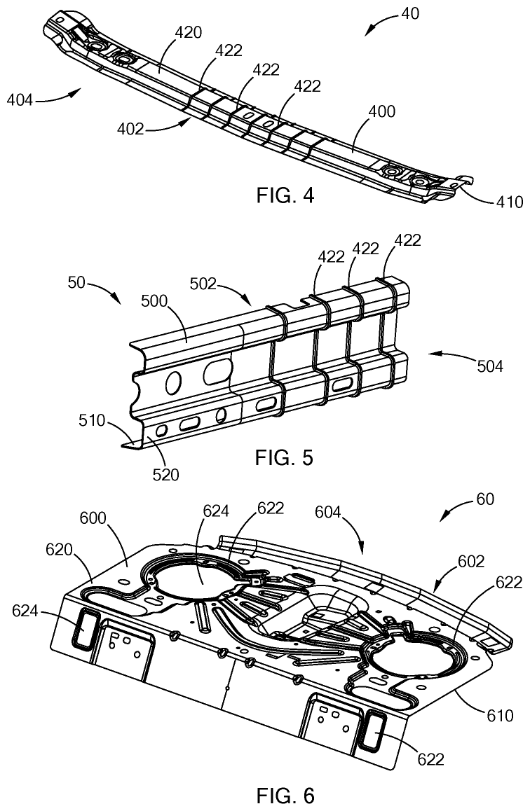

Referring to FIGS. 4-6, three non-limiting examples of sheet metal components formed before a reinforcement has been additively manufactured thereon are shown. Particularly, FIG. 4 shows a part 40 (e.g., a rail) that includes a sheet metal component 402 formed from a piece of sheet metal 400 into a predefined shape 404, and after which, an additively manufactured reinforcement 422 in the form of a plurality of reinforcement ribs 423 is deposited on and metallurgically bonded to a second surface 420 of the sheet metal component 402. As shown in FIG. 4, the plurality of reinforcement ribs 423 extend along the second surface 420 parallel to each other, i.e., the plurality of reinforcement ribs 423 is a plurality of parallel reinforcement ribs 423.

FIG. 5 shows a part 50 (e.g., a rail) that includes a sheet metal component 502 formed from a piece of sheet metal 500 into a predefined shape 504, and after which, an additively manufactured reinforcement 522 in the form of a plurality of reinforcement ribs 523 is deposited on and metallurgically bonded to a second surface 520 of the sheet metal component 502. As shown in FIG. 5, the plurality of reinforcement ribs 523 extend along the second surface 520 parallel to each other, i.e., the plurality of reinforcement ribs 523 is a plurality of parallel reinforcement ribs 523.

And FIG. 6 shows a part 60 (e.g., a package tray) that includes a sheet metal component 602 formed from a sheet metal panel 600 into a predefined shape 604, and after which, an additively manufactured reinforcement 622 in the form of a plurality of reinforcement ribs 623 is deposited on and metallurgically bonded to a second surface 620 of the sheet metal component 602. As shown in FIG. 6, the plurality of reinforcement ribs 623 extend along the second surface 620 proximal to a plurality of openings 624 such that areas, regions or sections of the sheet metal component 602 proximal the openings 624 have enhanced structural rigidity and/or strength for securing vehicle components such as electric devices (e.g., audio speakers), among others.

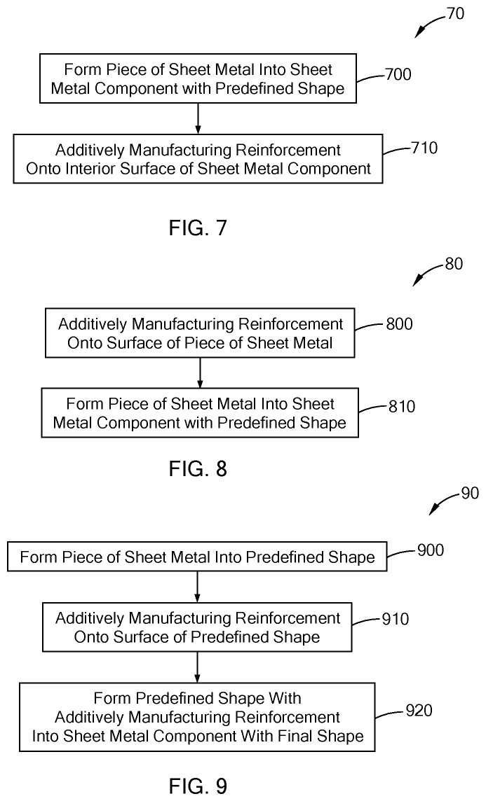

Referring to FIG. 7, a flow chart for a method 70 of forming a part according to the teachings of the present disclosure is shown. The method 70 includes forming a sheet metal panel into a sheet metal component with a predefined shape at 700 and depositing and metallurgically bonding an additively manufactured reinforcement onto an interior surface of the sheet metal component at 710. Accordingly, the additively manufactured reinforcement is deposited on and metallurgically bonded to the sheet metal component after it is formed.

Referring to FIG. 8, a flow chart for another method 80 of forming a part according to the teachings of the present disclosure is shown. The method 80 includes depositing and metallurgically bonding an additively manufactured reinforcement onto a second surface of a piece of sheet metal at 800 and forming the piece of sheet metal with the reinforcement into a sheet metal component with a predefined shape at 810. Accordingly, the additively manufactured reinforcement is deposited on and metallurgically bonded to the piece of sheet metal before the sheet metal component is formed.

Referring to FIG. 9, a flow chart for still another method 90 of forming a part according to the teachings of the present disclosure is shown. The method 90 includes forming a sheet metal panel into a predefined shape at 900 and depositing and metallurgically bonding an additively manufactured reinforcement onto a second surface of the predefined shape at 910. Then the predefined shape with the additively manufactured reinforcement is further formed into a sheet metal component at 920 with a final predefined shape. Accordingly, the additively manufactured reinforcement is deposited on and metallurgically bonded to the piece of sheet metal after is has been formed into a predefined shape (that is not a final shape), and then after the additively manufactured reinforcement has been deposited on and metallurgically bonded to the second surface, the piece of sheet metal is further formed into the sheet metal component with a final shape.

In some variations, the sheet metal panels and additively manufactured reinforcements disclosed herein are formed from metallic materials such as steels, stainless steels, aluminum alloys, among others. Non-limiting examples of steels used for forming the sheet metal component 100 include hot or cold rolled low carbon steels, High Strength Low Allow (HSLA) steels, Born steels, dual phase steels, Gen 3 steels, among others, and non-limiting examples of aluminum alloys used for forming the sheet metal component 100 include 5000, 6000, and 7000 series aluminum alloys such as 5052 and 6061 aluminum alloys, among others. Also, in some variations, the sheet metal panel is formed from a first material and the reinforcement is formed from the same first material. In other variations, the sheet metal panel is formed from a first material and the reinforcement is formed from a second material that is different from the first material.

It should be understood from the teachings of the present disclosure that enhanced flexibility in the design and manufacture of sheet metal components is provided. For example, in one form of the present disclosure, the sheet metal component has a visible surface, an interior surface, and the additively manufactured reinforcement is deposited on and metallurgically bonded to the interior surface after the piece of sheet metal is formed into a predefined shape. Accordingly, sheet metal components already designed and/or manufactured can have their structural rigidity and strength enhanced with “add-on” reinforcements. And such reinforcements inhibit deformation of areas or sections of the sheet metal components subject to oil canning and/or provide enhanced support for areas or sections of the sheet metal components where additional components such as speakers are to be secured. In another form of the present disclosure, the additively manufactured reinforcement is deposited on and metallurgically bonded to a surface of the piece of sheet metal before the piece of sheet metal is formed into a predefined shape. Accordingly, the additively manufactured reinforcements disclosed herein can be included in the design and manufacture of sheet metal components such that sheet metal panels include or have the additively manufactured reinforcements before being formed into a final shape.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A part comprising:
a sheet metal component formed into a predefined shape; and
at least one additively manufactured reinforcement deposited on, metallurgically bonded to, and extending along a surface of the sheet metal component.

2. The part according to claim 1, wherein the at least one additively manufactured reinforcement is formed by comprises a directed energy deposition (DED) reinforcement rib.

3. The part according to claim 1, wherein the at least one additively manufactured reinforcement is deposited on the piece of sheet metal before the piece of sheet metal is formed into the predefined shape.

4. The part according to claim 1, wherein the at least one additively manufactured reinforcement is deposited on the piece of sheet metal after the piece of sheet metal is formed into the predefined shape.

5. The part according to claim 1, wherein the at least one additively manufactured reinforcement is deposited on an oil canning surface of the predefined shape.

6. The part according to claim 1, wherein the at least one additively manufactured reinforcement is deposited proximal to an opening in the predefined shape.

7. The part according to claim 1, wherein the piece of sheet metal and the at least one additively manufactured reinforcement are both formed from a first material.

8. The part according to claim 1, wherein the piece of sheet metal is formed from a first material and the at least one additively manufactured reinforcement is formed from a second material different than the first material.

9. The part according to claim 1, wherein the piece of sheet metal and the at least one additively manufactured reinforcement are formed from a steel alloy.

10. The part according to claim 1, wherein the piece of sheet metal is formed from a first steel alloy and the at least one additively manufactured reinforcement is formed from a second steel alloy different from the first steel alloy.

11. The part according to claim 1, wherein the piece of sheet metal is formed from a first aluminum alloy and the at least one additively manufactured reinforcement is formed from a second aluminum alloy different from the first aluminum alloy.

12. The part according to claim 1, wherein the piece of sheet metal with the predefined shape is a visible sheet metal surface.

13. A motor vehicle comprising the part according to claim 1.

14. The part according to claim 1, wherein the at least one additively manufactured reinforcement comprises a plurality of additively manufactured reinforcement ribs.

15. The part according to claim 14, wherein the plurality of additively manufactured reinforcement ribs comprises at least one of parallel reinforcement ribs and reinforcement ribs forming a cross-hatch pattern.

16. A method of manufacturing a part comprising:
forming a piece of sheet metal into a predefined shape; and
additively manufacturing and metallurgically bonding at least one reinforcement onto the piece of sheet metal such that deformation of the predefined shape is inhibited.

17. The method according to claim 16, wherein the at least one reinforcement is additively manufactured onto the piece of sheet metal after the piece of sheet metal is formed into the predefined shape.

18. The method according to claim 16, wherein the at least one reinforcement is additively manufactured onto the piece of sheet metal before the piece of sheet metal is formed into the predefined shape.

19. A part formed by a method comprising:
forming a piece of sheet metal into a predefined shape; and
additively manufacturing and metallurgically bonding at least one reinforcement onto the piece of sheet metal such that deformation of the predefined shape is inhibited.

20. The part according to claim 19, wherein additively manufacturing the at least one reinforcement onto the piece of sheet metal comprises at least one of additively manufacturing a reinforcement onto the piece of sheet metal before forming the piece of sheet metal into the predefined shape and additively manufacturing a reinforcement onto the piece of sheet metal after forming the piece of sheet metal into the predefined shape.
